(19) United States
(12) Patent Application Publication
(10) Pub. No.: US 2009/0292796 A1
(43) Pub. Date: Nov. 26, 2009

(54) METHOD AND DEVICE FOR PROVIDING ROUTING POLICIES TO USER TERMINALS ACCORDING TO APPLICATIONS EXECUTED ON USER TERMINALS

(75) Inventor: HSIN-YAO HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/266,567

(22) Filed: Nov. 7, 2008

(30) Foreign Application Priority Data
May 23, 2008 (CN) 200810301742.2

(51) Int. Cl. G06F 15/16

(52) U.S. Cl. 709/222

(57) ABSTRACT

A method and system for providing routing policies to user terminals according to applications executed on the user terminals are provided. The method includes defining configurations for the user terminal and classifying the user terminal as a privileged user terminal or a common user terminal, retrieving a private IP address of the user terminal upon receipt of a connection request from the user terminal, recognizing the user terminal as the privileged user terminal or a common user terminal, and routing the connection request to a dynamic host configuration protocol (DHCP) server upon recognizing the user terminal as the privileged user terminal so as to obtain a reserved IP address for the privileged user terminal.

### BACKGROUND

1. Field of the Invention

Embodiments of the present disclosure relate to routing policies, and more particularly to a method and a system for providing routing policies to user terminals according to applications executed on the user terminals.

2. Description of Related Art

Network Address Translation (NAT) was developed in response to the declining number of available Internet Protocol (IP) addresses as more and more people are desiring to have access to the Internet. NAT is a method of connecting multiple computers to the Internet using only one IP address. With the number of available IP addresses decreasing each day, the usage of NAT becomes not only desirable, but necessary.

With NAT, one machine is designated as a gateway/router, and all the computers are connected to a gateway/router using private IP addresses. Private IP addresses are non-routable addresses as these addresses are not routed through Internet. The computers behind the NAT gateway will have private addresses and when communicating with the Internet, the machines send the data to the NAT gateway. The gateway performs the necessary address transaction to route the packet to the correct destination.

One drawback with NAT is that some applications cannot work within the NAT configuration (hereinafter referred to as “non-NAT-compliant applications”). Under the circumstances, the computers executing the non-NAT-compliant applications have to connect to other gateway device for connecting to the Internet.

Accordingly, a method and a device for providing NAT solution for user terminals executing both NAT-compliant non-NAT-compliant applications are called for in order to overcome the limitations described.

### BRIEF DESCRIPTION OF THE DRAWINGS

FIG. 1 is a system view of an embodiment of a system for providing routing policies to user terminals according to applications executed on the user terminals;

FIG. 2 is a block diagram of the IP gateway device of FIG. 1; and

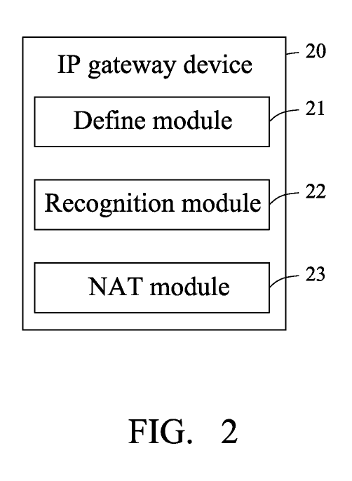

FIG. 3 is a flowchart of an embodiment of a method for providing routing policies to user terminals according to applications executed on the user terminals.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

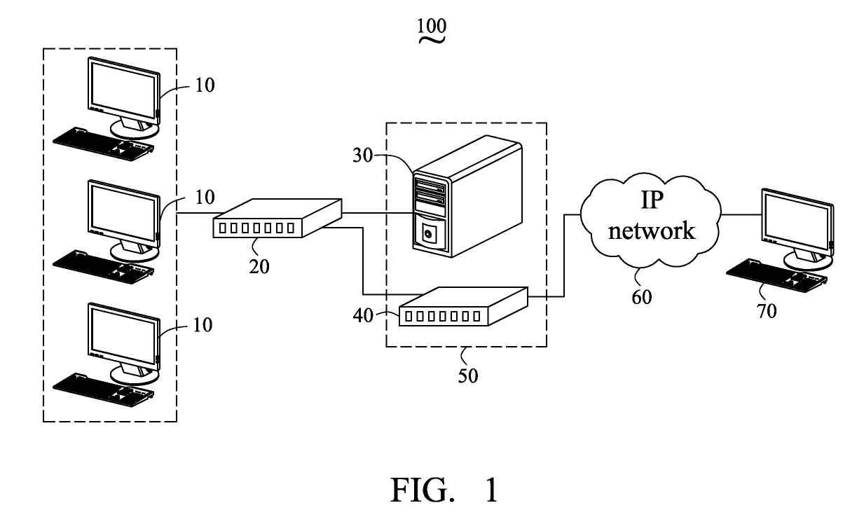

FIG. 1 is a system view of an embodiment of a system 100 for providing routing policies to user terminals according to applications executed on the user terminals (hereinafter “the system 100”). The system 100 includes at least one user terminal 10, an IP gateway device 20, a dynamic host configuration protocol (DHCP) server 30, a router 40 and a remote server 70. The user terminal 10 having a private IP address electrically connects to the IP gateway device 20. The IP gateway device 20 connects to the operators local area network (LAN) 50 by the DHCP server 30 and the router 40. The operators LAN 50 supports interworking between the IP gateway device 20 and an IP network 60 and establishes network connections between the user terminal 10 and the remote server 70.

In an embodiment, the user terminal 10 may be, a notebook computer, a server, or other device, without departing from the spirit of the disclosure. The user terminal 10 connects to remote server 70 for cooperatively executing a plurality of applications with the remote server 70 by the network connections provided by the IP gateway device 20, the operators LAN 50 and the IP network 60. The plurality of applications includes non-NAT-compliant applications and NAT-compliant applications.

The DHCP server 30 is configured for dynamic assignment of IP addresses to hosts, including the user terminal 10 and the IP gateway device 20, and for delivery of other configuration parameters such as sub-net mask and default router. The router 40 is configured for providing routes for packets between the IP network 60 and the IP gateway device 20.

The IP gateway device 20 routes the packets for the user terminal 10 using IP destination addresses. In an embodiment, the IP gateway device 20 has a plurality of global IP addresses (hereinafter referred to as “the gateway IP addresses”) identifying itself on the Internet. The plurality of global IP addresses are used for performing NAT functions and are shared by the user terminal 10 recognized as the common user terminal. In alternative embodiments, the IP gateway device 20 has only one global IP address.

In one embodiment, the IP gateway device 20 includes a define module 21, a recognition module 22, and a network address translation (NAT) module 23, in addition to other hardware and software components of the IP gateway device 20.

The define module 21 is configured for defining configurations for the user terminal 10, such as the private IP address of each user terminal 10, and the applications, including NAT-compliant applications and non-NAT-compliant applications, executed on the user terminal 10. Upon determining an execution of the non-NAT-compliant applications, the user terminal 10 is classified as a privileged user terminal. Otherwise, the user terminal 10 is classified as a common user terminal.

The recognition module 22 is configured for retrieving the private IP address of the user terminal 10 upon receipt of a connection request from the user terminal 10, and for recognizing whether the user terminal 10 is the privileged user terminal or the common user terminal based on the configurations.

The NAT module 23 is configured for routing the connection request based on whether the user terminal 10 is the privileged user terminal or the common user terminal. Upon recognizing the user terminal 10 as the privileged user terminal, the NAT module 23 routes the connection request to the DHCP server 30 so as to obtain a reserved IP address, which is a global address, for the privileged user terminal. Thus, the privileged user terminal is capable of cooperatively executing, specifically although not exclusively, non-NAT applications with the corresponding remote server 70 by using the reserved IP address until termination of the applications. In other words, the NAT module 23 does not perform address transaction for the privileged user terminal.

Upon recognizing the user terminal 10 as the common user terminal, the NAT module 23 translates the private IP address of the connection request sent from the user terminal 10 to one of the gateway IP addresses, and then routes the connection request to the router 40. The router 40 then connects the user terminal 10 to the remote server 70 by one of the gateway IP addresses. Understandably, response messages sent from the remote server 70 are directed to the one of the gateway IP address of the IP gateway device 20.

In addition, the NAT module 23 also maintains a NAT mapping table for monitoring current set of address translations that are in effect. Upon receipt of the response messages sent from the remote server 70, the NAT module 23 of the IP gateway device 20 interprets the response messages to identify the user terminal 10 sending the connection request based on the NAT mapping table. The response messages are then forwarded to the user terminal 10 from which the connection request is sent.

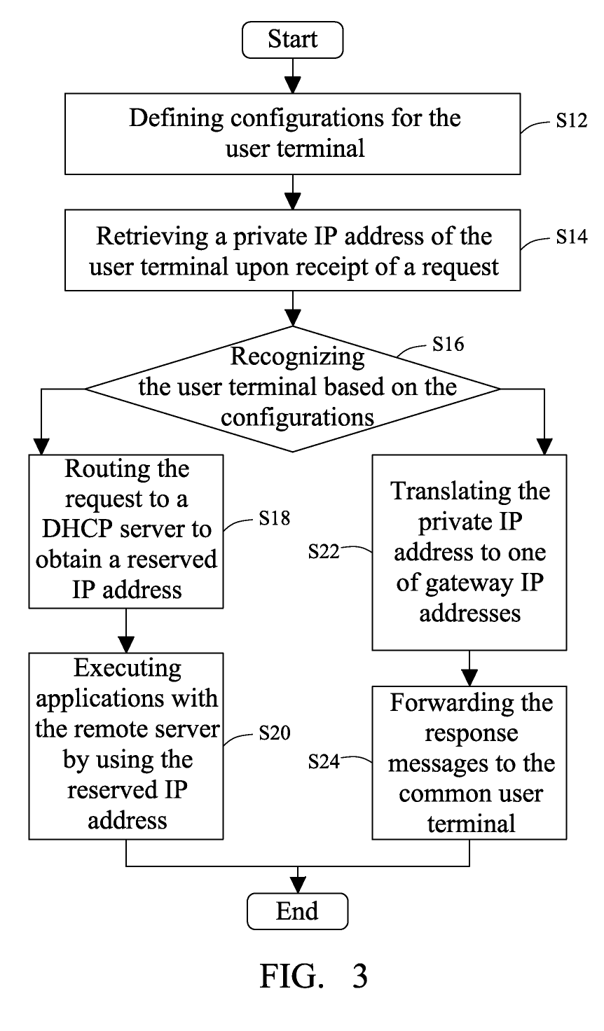

FIG. 3 is a flowchart of an embodiment of a method for providing routing policies to user terminal 10 according to applications executed on the user terminals. The method of FIG. 3 may used for routing the packets for the user terminal 10 running non-NAT-compliant applications by the IP gateway device 20. Depending on the embodiment, additional blocks may be added or deleted and the blocks may be executed in order other than that described.

In block S12, the define module 21 defines configurations for the user terminal 10. The configurations includes private IP address assigned to the user terminal 10, and the applications executed on the user terminal 10. In addition, the user terminal 10 is classified as a privileged user terminal or a common user terminal according to the application executed thereon.

In block S14, the recognition module 22 retrieves a private IP address of the user terminal 10 upon receipt of a connection request from the user terminal 10. In block S16, the recognition module 22 further recognizes the user terminal 10 based on the configurations. The user terminal 10 executes non-NAT-compliant applications is classified as a privileged user terminal. Otherwise, the user terminal 10 is classified as a common user terminal.

In block S18, the NAT module 23 routes the connection request to the DHCP server 30 upon recognizing the user terminal 10 as the privileged user terminal so as to obtain a reserved IP address for the privileged user terminal. It is to be noted that the reserved IP assigned from the DHCP server 30 is a global IP address.

In block S20, the user terminal 10 executes the applications with the remote server 70 by using the reserved IP address until termination of the applications if the user terminal 10 is the privileged user terminal.

In block S16, if the user terminal 10 is recognized as the common user terminal, in block S22, the NAT module 23 translates the private IP address of the user terminal 10 to one of the gateway IP addresses. It is to be noted that the gateway IP addresses are shared by the user terminals 10 recognized as the common user terminal. The NAT module 23 then sends the connection request to the remote server 70 by one of the gateway IP addresses and receives response messages sent from the remote server 70 to the one of the gateway IP address.

In block S24, the NAT module 23 interprets the response messages to identify the user terminal 10 sending the connection request based on the NAT mapping table. It is to be noted that the NAT mapping table records address translations between the private IP address of the user terminal 10 and one of the gateway IP addresses. The NAT module 23 then forwards the response messages to the common user terminal.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A gateway device for providing routing policies to user terminals according to applications executed on the user terminals, the device comprising:
a define module for defining configurations for the user terminal, the user terminal being classified as a privileged user terminal or a common user terminal according to the applications executed thereon;
a recognition module for retrieving a private Internet Protocol (IP) address of the user terminal upon receipt of a connection request from the user terminal and recognizing the user terminal based on the configurations; and
a network address translation module for routing the connection request to a dynamic host configuration protocol (DHCP) server upon recognizing the user terminal as the privileged user terminal so as to assign a reserved IP address to the privileged user terminal.

2. The device as claimed in claim 1, wherein the network address translation module is configured for translating a private IP address of the user terminal to one of gateway IP addresses upon recognizing the user terminal as the common user terminal, and the gateway IP addresses are shared by the user terminals recognized as the common user terminal.

3. The device as claimed in claim 2, wherein the privileged user terminal is capable of cooperatively executing the applications with remote servers by using the reserved IP address until termination of the applications.

4. The device as claimed in claim 2, wherein the common user terminal connects to the remote servers by one of the gateway IP addresses, and response messages sent from the remote servers are forwarded to the one of the gateway IP address of the network address translation module.

5. The device as claimed in claim 3, wherein the NAT module maintains a NAT mapping table for monitoring address translations between the private IP address of the user terminal and one of the gateway IP addresses.

6. The device as claimed in claim 5, wherein the network address translation module forwards the response messages to the common user terminal upon receipt of the response messages sent from the remote servers based on the configurations.

7. The device as claimed in claim 6, wherein the configurations includes private IP address assigned to the user terminal, and the applications executed on the user terminal.

8. A computer-implemented method for providing routing policies to user terminals according to applications executed on the user terminals, the method comprising:
defining configurations for the user terminal and classifying the user terminal as a privileged user terminal or a common user terminal according to the application executed thereon;
retrieving a private IP address of the user terminal upon receipt of a connection request from the user terminal;
recognizing the user terminal as the privileged user terminal or a common user terminal based on the configurations; and
routing the connection request to a dynamic host configuration protocol (DHCP) server upon recognizing the user terminal as the privileged user terminal so as to obtain a reserved IP address for the privileged user terminal.

9. The method as claimed in claim 8, wherein the routing step further comprises:
translating the private IP address of the user terminal to one of gateway IP addresses upon recognizing the user terminal as the common user terminal.

10. The method as claimed in claim 9, wherein the gateway IP addresses are shared by the user terminals recognized as the common user terminal.

11. The method as claimed in claim 8, wherein after the routing step, the method further comprises:
executing the applications with remote servers by using the reserved IP address until termination of the applications if the user terminal is the privileged user terminal.

12. The method as claimed in claim 8, wherein after the routing step, the method further comprises:
sending the connection request to the remote servers by one of the gateway IP addresses; and
receiving response messages sent from the remote server to the one of the gateway IP address.

13. The system as claimed in claim 12, wherein the method further comprises:
interpreting the response messages to identify the user terminal sending the connection request based on the NAT mapping table recording address translations between the private IP address of the user terminal and one of the gateway IP addresses; and
forwarding the response messages to the common user terminal upon receipt of the response messages sent from the remote servers.

14. The method as claimed in claim 13, wherein the configurations includes private IP address assigned to the user terminal, and the applications executed on the user terminal.
